(19) United States
(12) Patent Application Publication
(10) Pub. No.: US 2026/0302511 A1
(43) Pub. Date: Oct. 1, 2026

(54) Valve for an Electronic Component in Particular

(71) Applicant: Illinois Tool Works Inc., Glenview, IL (US)

(72) Inventors: Melanie Sindel, Nürnberg (DE); Jan Müller, Würzburg (DE)

(21) Appl. No.: 19/562,589

(22) Filed: Mar. 10, 2026

(30) Foreign Application Priority Data
Mar. 27, 2025 (DE) 10 2025 111 979.1

(51) Int. Cl. H01M 50/342; F16K 17/02

(52) U.S. Cl. CPC H01M 50/3425; F16K 17/02

(57) ABSTRACT

A pressure-relief valve for a component enclosure, particularly for electronic equipment, equalizes internal pressure with ambient pressure when the pressure inside the enclosure rises above a threshold. The valve includes a base body with a gas inlet region sized for insertion into a pressure equalization opening in the enclosure wall. A membrane system separates the gas inlet region from a gas outlet region and regulates gas flow through the valve. A cover protects the membrane on the outlet side. The valve also includes a support body connected to the base body. When the valve is installed in the enclosure opening, the support body braces the base body against the surrounding wall area of the enclosure. The structure improves mechanical stability of the valve and maintains reliable pressure relief under operating conditions.

### RELATED APPLICATION

The present application claims the benefit of German Patent Application No. DE 10 2025 111 979.1, filed Mar. 27, 2025, each titled “Valve for an Electronic Component in Particular,” the contents of which are hereby incorporated by reference.

### BACKGROUND

Battery cells are used as energy storage devices in a variety of ways. In particular, battery cells are used in battery systems comprising a plurality of such battery cells electrically connected to one or more battery modules. In particular, such battery systems are used to provide the energy required to operate hybrid, plug-in hybrid, or electric vehicles. Particularly preferably, lithium-ion cells are used as battery cells. Frequently, prismatic battery cells are used, which comprise a solid metallic cell casing. These metallic cell casings (also referred to as a hard case) protect the battery cell in particular from the penetration of moisture as well as the diffusion of electrolyte solvent molecules outwardly from the interior of the cell.

If such a battery cell heats up beyond a certain temperature, it can lead to a so-called degassing of the battery cell. Malfunctions, such as a short circuit between the electrodes of the battery cell, overcharging of the battery cell during a charging operation or an extremely high ambient temperature, can lead to such critical heating of the battery cell. As a result of such critical heating, undesired chemical reactions can occur in the battery cell, which can lead to a so-called thermal runaway. In particular, an electrolyte required for ion transport between the electrodes of a battery cell may decompose as a result of critical heating and transition to a gaseous state.

This gas formation results in a high pressure within the battery cell in a short time. A safety valve employed in the cell casing prevents a bursting of the battery cell, because the safety valve opens upon exceeding a certain internal cell pressure, so that a gas formed and possibly additionally formed decomposition products within the battery cell can escape via the opened safety valve as fluid from the cell casing.

A lithium-ion cell with such a safety valve is known from the publication DE 103 28 862 B4, for example, wherein the safety valve is configured as a metallic bursting membrane. Such a bursting membrane can, for example, be configured to burst upon an increase of an internal cell pressure prevailing within the cell casing of about 6 bar.

On the other hand, for example, a safety valve for a lead-acid battery configured as a valve plug is known from the publication DE 10 2007 061 784 A1.

In order to enable a rapid reduction in pressure in the casing even at a low degassing pressure, a degassing unit serving as a safety valve is known from the publication DE 10 2021 129 752 A1, in which a membrane is punctured with the aid of an emergency degassing mandrel when a critical internal pressure is reached.

### SUMMARY OF THE DISCLOSURE

The present disclosure relates generally to a valve, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, an exemplary embodiment of the valve according to the disclosure.

FIG. 2 illustrates schematically and in a second isometric view, the exemplary embodiment of the valve according to the disclosure of FIG. 1.

FIG. 3 illustrates schematically and in a cross-sectional view, the exemplary embodiment of the valve according to the disclosure of FIG. 1.

FIG. 4 illustrates schematically and in an isometric cross-sectional view, the exemplary embodiment of the valve according to the disclosure of FIG. 1.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a valve for a component, in particular an electronic component. In particular, the disclosure relates to a valve configured as a safety valve. The valve is in particular part of a degassing unit.

In particular, the disclosure relates to a safety valve for a battery case with least one battery cell housed in the battery case. The at least one battery cell is preferably a secondary cell, and in particular a lithium-ion battery cell.

The valve according to the disclosure is configured to open when an internal pressure prevailing within a casing of the in particular electronic component surpasses a threshold, and thus to allow a medium to flow out of the casing.

It should be emphasized that the scope of the disclosure is not limited to safety valves for battery cells. In general, the disclosure thus relates to valves for a component, in particular an electronic component, wherein the valves are configured to open when an internal pressure prevailing within a casing of the in particular electronic component surpasses a threshold, and thus to allow a medium to flow out of the casing.

In particular, the valve according to the disclosure is a valve that is used in a casing, particularly in the exterior area, for example of a vehicle, wherein the valve or the casing requires increased ingress protection against moisture/water.

For this purpose, it is necessary that the casing with the mounted valve can particularly withstand an IPX6 or even an IPX9/IPX9K test. This simulates, for example, the protection of the casing against the formation of a powerful water surge when driving through a puddle or the cleaning of a vehicle by steam jet cleaning. These tests were originally developed in the automotive industry but can be transferred to many day-to-day applications. For example, it makes sense to test an automatic parking machine or an e-bike parked on the roadside in accordance with IPX6K.

The IPX9 rating is tested in accordance with DIN EN 60529 (as of the application date) and is valid for electrical equipment, while IPX 9K is tested in accordance with ISO 20653 (as of the application date) and relates to electrical equipment mounted on road vehicles.

A test according to IPX9 requires that the force of a water jet is measured during the water test, while an IPX9K test requires that the pressure of the water jet is measured during the water test. In addition, the distance of the water jet nozzle for the IPX9 water test (200 mm) can be further distanced up to 50 mm compared to the IPX 9K water test (maximum 150 mm).

In order for a valve-equipped casing to withstand the force and/or pressure of the water jet during such a water test with regard to impermeability, particular attention must be paid to the area of the casing in which the valve is mounted.

The valve projects at least partially or regionally from a wall region of the casing and thus forms an increased contact surface for the water jet.

In this context, it is known from the automotive industry to associate a cover with the membrane system of the valve in order to cover the membrane system in the gas outlet region of the valve at least partially or regionally. This provides some protection of the membrane system against water penetration.

To further protect the valve from the force and/or pressure of the water jet, it is known from the automotive industry to integrally form a cage-like structure with the wall region of the casing, which wall region surrounds a pressure equalization aperture formed in the casing, in which aperture the valve is mounted, wherein the valve is then received within the cage-like structure of the casing and protected from external influences.

The object of the disclosure is to specify a valve of the above-mentioned type, which is configured as such to resist the force and/or pressure of the water jet, without a cage-like structure being provided integrally with the wall region of the casing.

Accordingly, the disclosure particularly relates to a valve for a component, in particular an electronic component, wherein the valve is configured to respond, in particular when a particularly previously determined or determinable critical internal pressure is reached or exceeded in a casing of the component, and to achieve pressure equalization with respect to atmospheric pressure.

The valve comprises a base body with a gas inlet region, which is designed in particular to be at least partially or regionally column-shaped, and which is at least partially received or receivable into a pressure equalization aperture of the casing of the component.

Moreover, the valve comprises a membrane system connected to the base body such that the membrane system separates the gas inlet region from a gas outlet region of the valve.

Furthermore, the valve comprises a cover associated with the membrane system, which is preferably connected to the base body and is configured to at least partially or regionally cover the membrane system in the gas outlet region of the valve.

According to a first aspect of the present disclosure, the valve according to the disclosure is in particular characterized by the valve further comprising a support body, which is connected or connectable to the base body and/or to the cover associated with the membrane system, and which is configured such that, at least in a state of the valve being mounted in the pressure equalization aperture of the casing of the component, at least the base body of the valve is mechanically supported against a wall region of the component surrounding the pressure equalization aperture.

It is conceivable that the base body of the valve comprises a stop, via which an insertion depth of the gas inlet region of the base body of the valve, which gas inlet region is designed at least partially or regionally in a column-shaped manner, into the pressure equalization aperture of the casing is limited, such that, in a state in which the valve is mounted in the pressure equalization aperture of the casing of the component, an upper end region of the gas inlet region of the base body of the valve, which gas inlet region is designed at least partially or regionally in a column-shaped manner, is located outside the pressure equalization aperture of the casing of the component.

According to a further (second) aspect of the present disclosure, the valve according to the disclosure is in particular characterized by the valve further a support body, which is connected or connectable to the base body and/or to the cover associated with the membrane system, and which, starting from the cover associated with the membrane system, extends in the direction of the gas inlet region of the base body, which gas inlet region is designed at least partially or regionally in a column-shaped manner, to such an extent that an edge region of the support body lies at least substantially in a plane, in which the upper end region of the gas inlet region of the base body of the valve, which gas inlet region is designed at least partially or regionally in a column-shaped manner, also lies.

In preferred implementations of the valve according to the disclosure, the valve comprises a seal associated with the gas inlet region, which is designed in particular at least partially or regionally in a column-shaped manner, in particular in the form of a sealing ring, preferably an O-ring, via which the gas inlet region of the base body of the valve, which gas inlet region is designed in particular at least partially or regionally in a column-shaped manner, is fluid-tightly connected or connectable to an edge of the pressure equalization aperture of the casing.

In this context, it is particularly suitable for the support body of the valve to extend from the cover associated with the membrane system in the direction of the gas inlet region of the base body, which gas inlet region is designed at least partially or regionally in a column-shaped manner, to such an extent that the seal associated with the gas inlet region, which is designed in particular at least partially or regionally in a column-shaped manner, is laterally covered at least partially or regionally, and preferably completely, by the support body.

According to further (third) aspect, the disclosure relates to a valve for a component, in particular an electronic component, wherein the valve is configured to respond, in particular when a particularly previously determined or determinable critical internal pressure is reached or exceeded in a casing of the component, and to achieve pressure equalization with respect to atmospheric pressure. The valve comprises a base body with a gas inlet region, which is designed in particular to be at least partially or regionally column-shaped, and which is at least partially received or receivable into a pressure equalization aperture of the casing of the component. Moreover, the valve comprises a membrane system connected to the base body such that the membrane system separates the gas inlet region from a gas outlet region of the valve. Furthermore, the valve comprises a cover associated with the membrane system, which is preferably connected to the base body and is configured to at least partially or regionally cover the membrane system in the gas outlet region of the valve.

The valve according to the third aspect of the disclosure comprises a seal associated with the gas inlet region, which is designed in particular at least partially or regionally in a column-shaped manner, in particular in the form of a sealing ring, preferably an O-ring, via which the gas inlet region of the base body of the valve, which gas inlet region is designed in particular at least partially or regionally in a column-shaped manner, is fluid-tightly connected or connectable to an edge of the pressure equalization aperture of the casing.

The valve according to the third aspect of the disclosure is in particular wherein the valve further comprises a support body which is connected or connectable to the base body and/or to the cover associated with the membrane system, and which extends from the cover associated with the membrane system in the direction of the gas inlet region of the base body, which gas inlet region is designed at least partially or regionally in a column-shaped manner, to such an extent that the seal associated with the gas inlet region, which is designed in particular at least partially or regionally in a column-shaped manner, is laterally covered at least partially or regionally, and preferably completely, by the support body.

In implementations of the valve according to the disclosure, it is provided that the cover associated with the membrane system is at least substantially embodied as a flat cover plate, wherein the support body of the valve has an at least substantially skirt-shaped or skirt-like configuration and preferably completely surrounds the base body of the valve.

It is conceivable that the support body of the valve is fixedly connected to the cover associated with the membrane system and is in particular integrally connected to the cover associated with the membrane system.

Alternatively, however, the support body of the valve can be preferably releasably connected or connectable to the cover associated with the membrane system, in particular via a clip connection.

Preferably, at least one gas outlet aperture and preferably a plurality of gas outlet apertures are provided between the support body of the valve and the cover associated with the membrane system, via which the gas outlet region of the valve is fluidly connected to the external atmosphere.

In principle, it is possible for the valve to further comprise an emergency degassing unit, which is configured to puncture and/or slit the membrane when the critical internal pressure is reached or exceeded such that, at least in the punctured and/or slit area of the membrane, fluid permeability of the membrane that is necessary and/or desired for pressure compensation is increased accordingly.

In preferred implementations of the valve according to the disclosure, the gas inlet region of the base body of the valve, which gas inlet region is designed at least partially or regionally in a column-shaped manner, is fluidly connected or connectable to an edge of the pressure equalization aperture of the casing, wherein the membrane covers a gas passage aperture formed in the base body.

With regard to the membrane system of the valve according to the disclosure, different design variants are possible. It is conceivable, for example, that the membrane system in particular comprises a membrane particularly configured as a semi-permeable membrane, which is designed to enable a passage of gaseous media from an environment into the casing of the in particular electronic component and/or vice versa, but to prevent the passage of liquid media and/or solids.

Alternatively, the membrane system may comprise a membrane, wherein the membrane is configured as a bursting disc.

Preferably, the valve according to the disclosure meets the IPx9K IP protection rating (as of the application date).

The disclosure further relates to an assembly with a component, in particular an electronic component, comprising a casing and with a valve of the type according to the disclosure previously described, wherein the valve is mounted in a pressure equalization aperture of the casing of the component.

The exemplary embodiment of the valve 1 according to the disclosure is in particular a safety valve for, for example, a battery comprising at least one battery cell housed in a battery case. The valve 1 can be incorporated into a pressure equalization aperture 100 of the battery casing. The battery cell is in particular a secondary cell, preferably in the form of a lithium-ion cell.

The valve 1 is designed to be actuated and achieve pressure equalization with respect to atmospheric pressure when a particularly previously determined or determinable critical internal pressure is reached or exceeded in the (battery) casing.

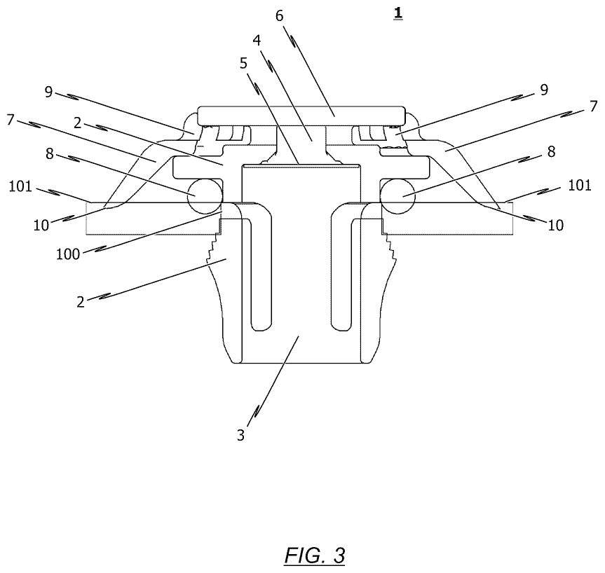

For this purpose, the valve 1 comprises a base body 2 with a gas inlet region 3, which is designed in particular to be at least partially or regionally column-shaped, and which is at least partially received or receivable into a pressure equalization aperture 100 of the casing of the component (see FIG. 3).

The valve 1 further comprises a membrane system 5 connected to the base body 2 such that the membrane system 5 separates the gas inlet region 3 from a gas outlet region 4 of the valve 1.

In the exemplary embodiment of the valve 1 according to the disclosure shown in the drawings, the membrane system 5 in particular comprises a semi-permeably configured membrane, which is designed to enable a passage of gaseous media from an environment into the casing of the in particular electronic component and/or vice versa, but to prevent the passage of liquid media and/or solids.

Alternatively, however, it is also conceivable that the membrane system 5 comprises a membrane embodied as a bursting disc.

Finally, according to the exemplary embodiment shown in the drawings, the valve 1 comprises a cover 6 associated with the membrane system 5, which is preferably connected to the base body 2 and configured to cover the membrane system 5 at least partially or regionally in the gas outlet region 4 of the valve 1.

The valve 1 according to the exemplary embodiment shown in the drawings is in particular wherein the valve 1 further comprises a support body 7, which is connected or connectable to the base body 2 and/or to the cover 6 associated with the membrane system 5 and is configured such that, at least in a state of the valve 1 being mounted in the pressure equalization aperture 100 of the casing of the component, at least the base body 2 of the valve 1 is mechanically supported against a wall region 101 of the component surrounding the pressure equalization aperture 100.

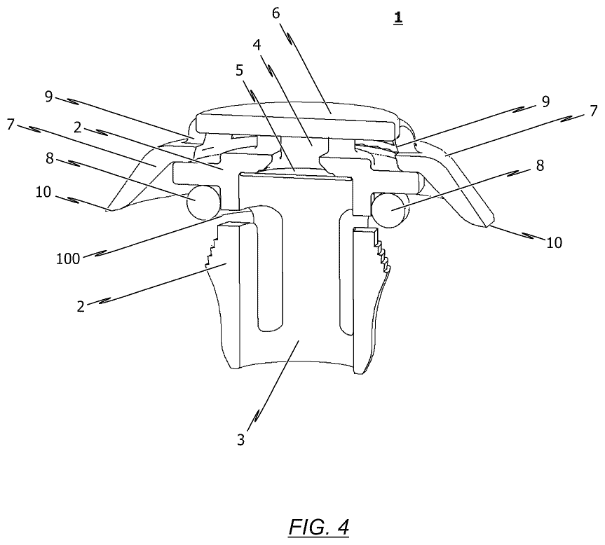

As can be seen from the cross-sectional views according to FIG. 3 and FIG. 4, in the exemplary embodiment of the valve 1 according to the disclosure it is provided that the base body 2 comprises a stop, via which an insertion depth of the gas inlet region 3 of the base body 2 of the valve 1, which gas inlet region is designed to be at least partially or regionally in a column-shaped manner, into the pressure equalization aperture 100 of the casing is limited, such that, in a state in which the valve 1 is mounted in the pressure equalization aperture 100 of the casing of the component, an upper end region of the gas inlet region 3 of the base body 2 of the valve 1, which gas inlet region is designed at least partially or regionally in a column-shaped manner, is located outside the pressure equalization aperture 100 of the casing of the component.

In particular, it is provided that the support body 7 of the valve 1 extends from the cover 6 associated with the membrane system 5 in the direction of the gas inlet region 3 of the base body 2, which gas inlet region is configured at least partially or regionally in a column-shaped manner, to such an extent that an edge region 10 of the support body 7 lies at least substantially in a plane, in which the upper end region of the gas inlet region 3 of the base body 2 of the valve 1, which gas inlet region is configured at least partially or regionally in a column-shaped manner, also lies.

As can further be taken from the cross-sectional views in FIG. 3 and FIG. 4, in the exemplary embodiment of the valve 1 according to the disclosure it is provided that the valve 1 comprises a seal 8 associated with the gas inlet region 3, which is designed in particular at least partially or regionally in a column-shaped manner, in particular in the form of a sealing ring, preferably an O-ring, via which the gas inlet region 3 of the base body 2 of the valve 1, which gas inlet region is designed in particular at least partially or regionally in a column-shaped manner, is fluid-tightly connected or connectable to a wall region 101 of the edge of the pressure equalization aperture 100 of the casing.

In particular, it is provided that the support body 7 of the valve 1 extends from the cover 6 associated with the membrane system 5 in the direction of the gas inlet region 3 of the base body 2, which gas inlet region is designed at least partially or regionally in a column-shaped manner, to such an extent that the seal 8 associated with the gas inlet region 3, which is designed in particular at least partially or regionally in a column-shaped manner, is laterally covered at least partially or regionally, and preferably completely, by the support body 7.

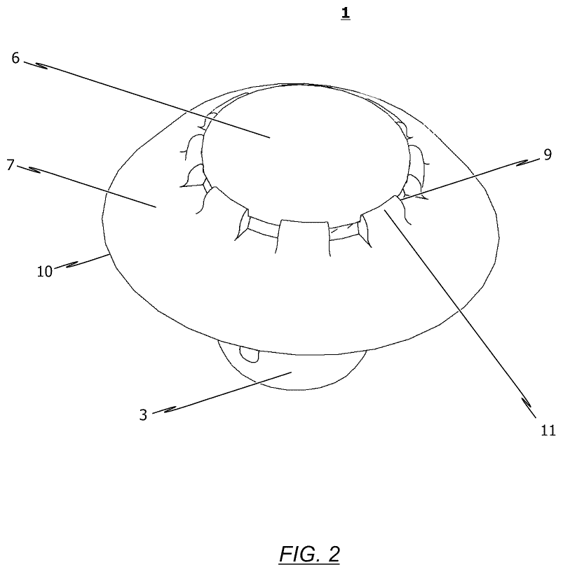

The view according to FIG. 2 shows that the cover 6 associated with the membrane system 5 is at least substantially designed as a particularly flat cover plate. It can further be seen that the support body 7 of the valve 1 comprises a configuration that is at least substantially skirt-shaped or skirt-like and preferably completely surrounds the base body 2 of the valve 1.

In principle, it is conceivable that the support body 7 of the valve 1 is fixedly connected to the cover 6 associated with the membrane system 5 and is in particular integrally connected to the cover 6 associated with the membrane system 5.

However, in the exemplary embodiment of the valve 1 according to the disclosure shown in the drawings, it is provided that the support body 7 of the valve 1 is preferably releasably connected or connectable to the cover 6 associated with the membrane system 5, in particular via a clip connection 11.

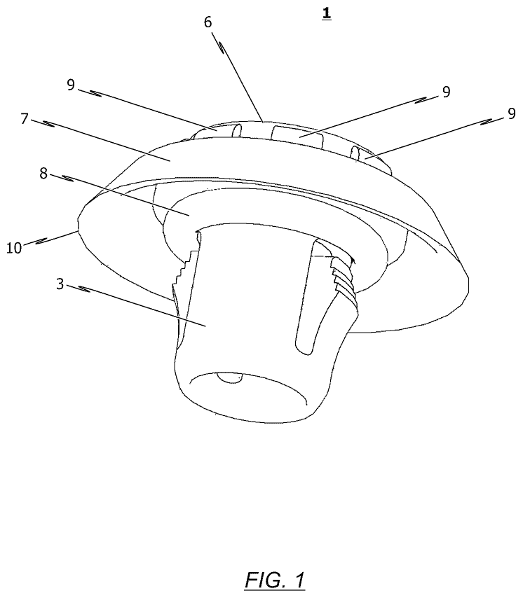

In particular, FIG. 1 also shows that a plurality of gas outlet apertures 9 is provided between the support body 7 of the valve 1 and the cover 6 associated with the membrane system 5, via which the gas outlet region 4 of the valve 1 is fluidly connected to the external atmosphere.

The cross-sectional view according to FIG. 3 or FIG. 4 shows that the gas inlet region 3 of the base body 2 of the valve 1, which gas inlet region is in particular designed at least partially or regionally in a column-shaped manner, is fluid-tightly connected or connectable to a wall region 101 of an edge of the pressure equalization aperture 100 of the casing, wherein the membrane system 5 covers a gas passage aperture formed in the base body 2.

The disclosure is not limited to the embodiments shown in the drawings, but rather results when all of the features disclosed herein are considered together.

It is particularly conceivable in this context for the valve 1 to further comprise an emergency degassing unit, which is configured to puncture and/or slit a membrane of the membrane system 5 when the critical internal pressure is reached or exceeded such that, at least in the punctured and/or slit area of the membrane, fluid permeability of the membrane that is necessary and/or desired for pressure equalization is increased accordingly.

Furthermore, the disclosure relates to an assembly with a component, in particular an electronic component, comprising a casing and with a valve 1, wherein the valve 1 is mounted in a pressure equalization aperture 100 of the casing of the component.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Valve
2 Base body
3 Gas inlet region
4 Gas outlet region
5 Membrane system
6 Cover
7 Support body
8 Seal
9 Gas outlet aperture
10 Edge region of the support body
11 Clip connection
100 Pressure equalization aperture
101 Wall region

What is claimed is:

1. A valve (1) for a component, wherein the valve (1) is configured to respond when a particularly previously determined or determinable critical internal pressure is reached or exceeded in a casing of the component, and to achieve pressure equalization with respect to atmospheric pressure, wherein the valve (1) comprises:
a base body (2) with a gas inlet region (3), which is designed to be at least partially or regionally column-shaped, and which is at least partially received or receivable into a pressure equalization aperture (100) of the casing of the component;
a membrane system (5) connected to the base body (2) such that the membrane system (5) separates the gas inlet region (3) from a gas outlet region (4) of the valve (1); and
cover (6) associated with the membrane system (5), which is preferably connected to the base body (2) and is configured to at least partially or regionally cover the membrane system (5) in the gas outlet region (4) of the valve (1),
wherein the valve (1) further comprises a support body (7) connected or connectable to the base body (2) and/or to the cover (6) associated with the membrane system (5) and configured such that, at least in a state of the valve (1) mounted in the pressure equalization aperture (100) of the component casing, at least the base body (2) of the valve (1) is mechanically supported against a wall region (101) of the component surrounding the pressure equalization aperture (100).

2. The valve (1) according to claim 1,
wherein the base body (2) comprises a stop, via which an insertion depth of the gas inlet region (3) of the base body (2) of the valve (1), which gas inlet region is designed at least partially or regionally in a column-shaped manner, into the pressure equalization aperture (100) of the casing is limited, such that, in a state in which the valve (1) is mounted in the pressure equalization aperture (100) of the casing of the component, an upper end region of the gas inlet region (3) of the base body (2) of the valve (1), which gas inlet region is designed at least partially or regionally in a column-shaped manner, is located outside the pressure equalization aperture (100) of the casing of the component,
wherein the valve (1) further comprises a support body (7), which is connected or connectable to the base body (2) and/or to the cover (6) associated with the membrane system (5), and which, starting from the cover (6) associated with the membrane system

(5) extends in the direction of the gas inlet region (3) of the base body (2), which gas inlet region is designed at least partially or regionally in a column-shaped manner, to such an extent that an edge region (10) of the support body (7) lies at least substantially in a plane, in which the upper end region of the gas inlet region (3) of the base body (2) of the valve (1), which gas inlet region is designed at least partially or regionally in a column-shaped manner, also lies.

3. The valve (1) according to claim 1,
wherein the valve (1) comprises a seal (8) associated with the gas inlet region (3), wherein the gas inlet region (3) of the base body (2) of the valve (1), which is designed at least partially or regionally in a column-shaped manner, is fluid-tightly connected or connectable to a wall region (101) of the edge of the pressure equalization aperture (100) of the casing.

4. The valve (1) according to claim 3,
wherein the support body (7) of the valve (1) extends from the cover (6) associated with the membrane system (5) in the direction of the gas inlet region (3) of the base body (2), such that the seal (8) associated with the gas inlet region (3), which is designed at least partially or regionally in a column-shaped manner, is laterally covered at least partially or regionally, and preferably completely, by the support body (7).

5. The valve (1) according to claim 1,
wherein the valve (1) comprises a seal (8) associated with the gas inlet region (3), via which the gas inlet region (3) of the base body (2) of the valve (1), which gas inlet region is designed at least partially or regionally in a column-shaped manner, is fluid-tightly connected or connectable to an edge of the pressure equalization aperture (100) of the casing,
wherein the valve (1) further comprises a support body (7), which is connected or connectable to the base body (2) and/or to the cover (6) associated with the membrane system (5), and which extends from the cover (6) associated with the membrane system (5) in the direction of the gas inlet region (3) of the base body (2) such that the seal (8) associated with the gas inlet region (3), which is designed at least partially or regionally in a column-shaped manner, is laterally covered at least partially or regionally, and preferably completely, by the support body (7).

6. The valve (1) according to claim 1,
wherein the cover (6) associated with the membrane system (5) is at least substantially designed as a particularly flat cover plate, and wherein the support body (7) of the valve (1) has an at least substantially skirt-shaped or skirt-like configuration and preferably completely surrounds the base body (2) of the valve (1).

7. The valve (1) according to claim 1,
wherein the support body (7) of the valve (1) is fixedly connected to the cover (6) associated with the membrane system (5) and is integrally connected to the cover (6) associated with the membrane system (5).

8. The valve (1) according to claim 1,
wherein the support body (7) of the valve (1) is via a clip connection (11), preferably releasably connected or connectable to the cover (6) associated with the membrane system (5).

9. The valve (1) according to claim 1,
wherein at least one gas outlet aperture (9) and preferably a plurality of gas outlet apertures (9) are provided between the support body (7) of the valve (1) and the cover (6) associated with the membrane system (5), via which the gas outlet region (4) of the valve (1) is fluidly connected to the external atmosphere.

10. The valve (1) according to claim 1,
whereby the valve (1) further comprises an emergency degassing unit, which is configured to puncture and/or slit a membrane of the membrane system (5) when the critical internal pressure is reached or exceeded such that, at least in the punctured and/or slit area of the membrane, fluid permeability of the membrane that is necessary and/or desired for pressure equalization is increased accordingly.

11. The valve (1) according to claim 1,
wherein the gas inlet region (3) of the base body (2) of the valve (1), which is designed at least partially or regionally in a column-shaped manner, is fluid-tightly connected or connectable to a wall region (101) of an edge of the pressure equalization aperture (100) of the casing, and wherein the membrane system (5) covers a gas passage aperture formed in the base body (2).

12. The valve (1) according to claim 1,
wherein the membrane system (5) comprises a semi-permeably configured membrane, which is configured to enable the passage of gaseous media from an environment into the casing of the electronic component and/or vice versa, while preventing the passage of liquid media and/or solids.

13. The valve (1) according to claim 1,
wherein the membrane system (5) comprises a membrane configured as a rupture disc.

14. The valve (1) according to claim 1,
wherein the valve (1) meets the IP protection rating IPx9K (as of the application date).

15. An assembly with a component, which comprises a casing, and with a valve (1) according to claim 1, wherein the valve (1) is mounted in a pressure equalization aperture (100) of the casing of the component.
